(19) United States
(12) Patent Application Publication
(10) Pub. No.: US 2018/0156330 A1
(43) Pub. Date: Jun. 7, 2018

(54) METHOD OF CONTROLLING A TRANSMISSION TO SIMULATE CLUTCH PEDAL FUNCTIONALITY

(71) Applicant: GM GLOBAL TECHNOLOGY OPERATIONS LLC, Detroit, MI (US)

(72) Inventors: Orson S. Wang, Novi, MI (US); Tadge J. Juechter, Troy, MI (US); Michael G. Petrucci, Howell, MI (US); Mark A. Vernacchia, Northville, MI (US)

(73) Assignee: GM GLOBAL TECHNOLOGY OPERATIONS LLC, Detroit, MI (US)

(21) Appl. No.: 15/366,485

(22) Filed: Dec. 1, 2016

(51) Int. Cl. F16H 61/02

(52) U.S. Cl. CPC F16H 61/0248; F16H 59/44

(57) ABSTRACT

A method of controlling a transmission includes initiating a temporary neutral mode of the transmission, in which at least one clutch of the transmission is disengaged to prevent power flow through the transmission, when an upshift paddle selector and a downshift paddle selector are both engaged within a pre-defined engagement time window. At least one of the upshift paddle selector and the downshift paddle selector is held in their respective engaged positions to maintain the temporary neutral mode of the transmission. The temporary neutral mode of the transmission is ended when both of the upshift paddle selector and the downshift paddle selector are disengaged, by re-engaging the at least one transmission clutch that was disengaged to initiate the temporary neutral mode.

### TECHNICAL FIELD

The disclosure generally relates to a method of controlling an electronically controlled transmission of a vehicle.

### BACKGROUND

Electronically controlled transmissions are controlled by a transmission control module to automatically change a gear ratio to meet current and requested driving conditions. An operator typically selects a mode with a mode selector device, commonly referred to as a range selector or shifter. The different transmission operating modes may include, but are not limited to, a forward driving mode, a reverse driving mode, a park mode, or a neutral mode.

Some vehicles are equipped with paddle shifters, e.g., an upshift paddle selector and a downshift paddle selector, which enable the operator to manually request a sequential increase or decrease in the gear ratio. Often, the paddle shifters are located on the steering column or on the steering wheel. Pressing and releasing the upshift paddle selector requests the transmission control module to increase the gear ratio of the transmission to the next available higher gear ratio. Pressing and releasing the downshift paddle selector requests the transmission control module to decrease the gear ratio of the transmission to the next available lower gear ratio. In order to control a vehicle equipped with paddle shifters, the operator must first select the operating mode of the transmission with the mode selector device, and may then use the paddle shifters to control the desired gear ratio of the transmission, if desired. Alternatively, if the operator does not desire to use the paddle shifters, the transmission control module may automatically control the gear ratio of the transmission.

### SUMMARY

A method of controlling an electronically controlled transmission of a vehicle is provided. The method includes positioning a transmission mode selector in a forward drive mode or a rearward drive mode to request a power flow path through the transmission. The transmission is configured to provide the requested power flow path through the transmission. Both upshift paddle selector and a downshift paddle selector are engaged within a pre-defined engagement time window. When the upshift paddle selector and the downshift paddle selector are both engaged within the pre-defined engagement time window, at least one clutch of the transmission is disengaged to prevent power flow through the transmission, without otherwise changing the power flow path through the transmission, to simulate a neutral operating mode of the transmission.

Accordingly, the method may be used to simulate the functionality of a clutch pedal for a manual transmission, with an electronically controlled transmission. Accordingly, a driver may perform maneuvers that are normally possible with a clutch pedal, and are not normally possible with an electronically controlled automatic transmission.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic illustration of a vehicle.

FIG. 2 is a plot showing engagement and disengagement of an upshift paddle selector and a downshift paddle selector in a first scenario.

FIG. 3 is a plot showing engagement and disengagement of the upshift paddle selector and the downshift paddle selector in a second scenario.

FIG. 4 is a plot showing engagement and disengagement of the upshift paddle selector and the downshift paddle selector in a third scenario.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

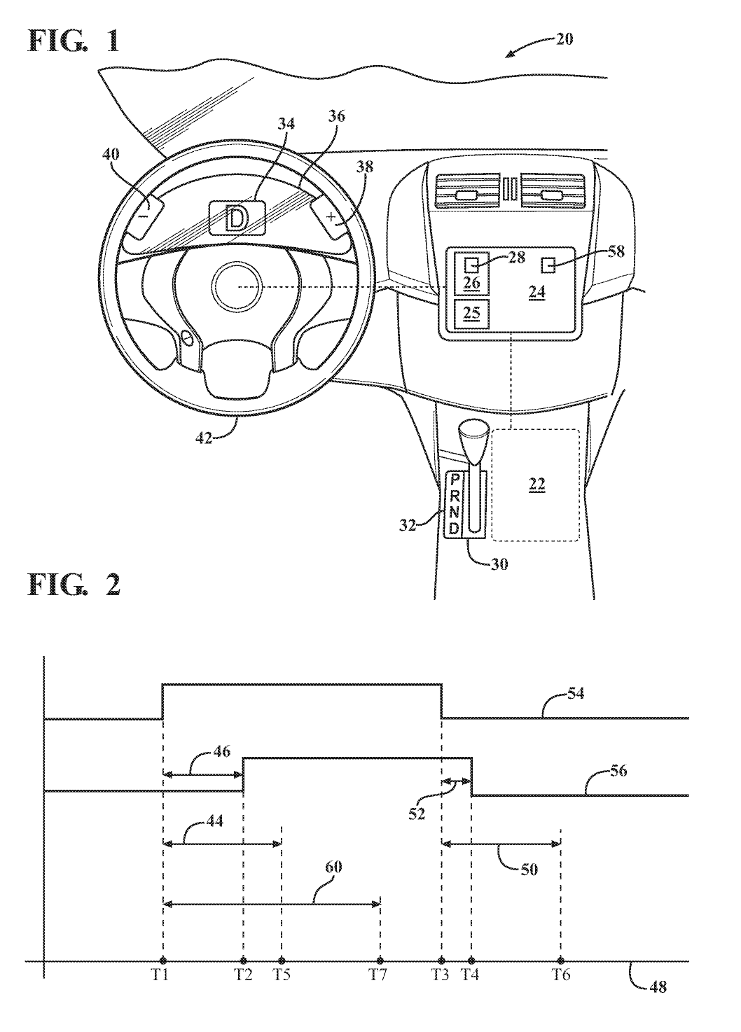

Referring to the Figures, wherein like numerals indicate like parts throughout the several views, a vehicle is generally shown at 20. Referring to FIG. 1, the vehicle 20 may include any type of vehicle 20 having an electronically controlled transmission 22. For example, the vehicle 20 may include, but is not limited to, a car, truck, or some other similar form of conveyance. The electronically controlled transmission 22 may include any type of transmission 22 that is controlled electronically. For example, the transmission 22 may include, but is not limited to, an automatic transmission, an automatic manual transmission, a dual clutch transmission, or a continuously variable transmission. Other than described herein, the specific type and/or operation of the transmission 22 is not pertinent to the teachings of this disclosure, and are therefore not described in detail herein.

The operation of the transmission 22 is controlled by a transmission control module 24. The transmission control module 24 may be referred to as a controller, vehicle 20 controller, control module, TCM, computer, etc. The transmission control module 24 may include a computer and/or processor 25, and include all software, hardware, memory, algorithms, connections, sensors, etc., necessary to manage and control the operation of the transmission 22. As such, a method, described below may be embodied as a program or algorithm operable on the transmission control module 24. It should be appreciated that the transmission control module 24 may include any device capable of analyzing data from various sensors, comparing data, making the necessary decisions required to control the operation of the transmission 22, and executing the required tasks necessary to control the operation of the transmission 22.

The transmission control module 24 may be embodied as one or multiple digital computers or host machines each having one or more processors 25, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The transmission control module 24 includes tangible, non-transitory memory 26 on which are recorded computer-executable instructions, including a simulated neutral algorithm 28. The processor 25 of the transmission control module 24 is configured for executing the simulated neutral algorithm 28. The simulated neutral algorithm 28 implements a method of controlling the transmission 22, described in greater detail below.

The vehicle 20 includes a transmission mode selector 30. The mode selector 30 may alternatively be referred to as a transmission range selector or shifter. The transmission mode selector 30 is controlled by an operator, and is used to select a desired operating range or mode of the transmission 22. For example, the transmission 22 may be operable in either a forward drive mode (D) for rotating at least one drive wheel in a first direction to propel the vehicle 20 in a first or forward direction, or a reverse drive mode (R) for rotating at least one drive wheel in a second direction to propel the vehicle 20 in a second or rearward direction. Additionally, the transmission 22 may be placed in a park mode (P) for preventing rotation of the drive wheels, or a neutral mode (N) for allowing free, un-propelled rotation of the drive wheels. The transmission 22 may include other operating modes not specifically mentioned or described herein. For example, the transmission 22 may include multiple different forward drive modes.

The transmission mode selector 30 may be configured in any manner that allows the operator to select the forward drive mode, the rearward drive mode, the park mode, or the reverse mode. For example, the transmission mode selector 30 may include a lever that is slideably moveable between different positions to select the different operating modes of the transmission 22, one or more buttons that may be depressed to select the different operating modes of the transmission 22, or a rotary dial that is depressible and/or rotatable to select the different operating modes of the transmission 22. The transmission mode selector 30 is linked to the transmission control module 24, and is an input device that allows the operator to select the desired operating mode of the transmission 22.

The transmission mode selector 30 may include a transmission mode indicator 32 that identifies the current operating mode of the transmission 22. The transmission mode indicator 32 may include printed or lighted indicia, such as “P R N D”, commonly used to designate the different operating modes of the transmission 22. It should be appreciated that the transmission mode indicator 32 may be configured in some other manner that described herein.

In addition to the transmission mode indicator 32 located on the transmission mode selector 30, the vehicle 20 may further include a second transmission mode indicator 34 located on an instrument panel 36 of the vehicle 20. The second transmission mode indicator 34 also displays some form of indicia or indicator to identify the current operating mode of the transmission 22. For example, the second transmission mode indicator 34 may also display the common “P R N D” symbols commonly displayed at the transmission mode selector 30. However, the indicia displayed by the second transmission mode indicator 34 may differ from the indicia displayed by the transmission mode indicator 32 on the transmission mode selector 30. The second transmission mode selector 30 may convey additional information by displaying an altered, modified, or additional symbol. For example, if the vehicle 20 is equipped with paddle shifters, the second transmission mode selector 30 may display another symbol, such as “M” indicating that the transmission 22 is operating in a manual gear selection forward drive mode.

The vehicle 20 further includes an upshift paddle selector 38, and a downshift paddle selector 40. The upshift paddle selector 38 allows the operator to manual request that the transmission control module 24 increase a gear ratio of the transmission 22 to the next higher gear ratio. The downshift paddle selector 40 allows the operator to manually request that the transmission control module 24 decrease the gear ratio of the transmission 22 to the next lower gear ratio. The upshift paddle selector 38 and the downshift paddle selector 40 may be located at any appropriate location, suitable and convenient for the operator to engage. For example, the upshift paddle selector 38 and the downshift paddle selector 40 may be located and attached to a steering wheel 42, so that the operator may actuate them without removing their hands from the steering wheel 42. The upshift paddle selector 38 and the downshift paddle selector 40 are disposed in electronic communication with the transmission control module 24, and allow the operator to input commands into the transmission control module 24.

As noted above, the transmission control module 24 executes the simulated neutral algorithm 28 to control the operation of the transmission 22. The simulated neutral algorithm 28 configures the transmission 22 to simulate the neutral operating mode of the transmission 22, while maintaining the transmission 22 in a condition capable of a quick launch. As such, the simulated neutral algorithm 28 simulates a manually controlled transmission 22 positioned in a drive gear, with a clutch pedal depressed to disconnect or disrupt the power flow path between the prime mover, e.g., an engine, and the transmission 22.

In order to execute the simulated neutral algorithm 28, the transmission 22 must be currently configured in a drive mode, e.g., the forward drive mode or the rearward drive mode. Accordingly, the transmission mode selector 30 must be positioned in either the forward drive mode position or the rearward drive mode position to request a power flow path through the transmission 22. The transmission control module 24 may then configure the transmission 22 to provide the requested power flow path, e.g., the forward drive mode or the rearward drive mode. Exactly how the transmission control module 24 configures the transmission 22 is dependent upon the precise type and configuration of the transmission 22. However, generally speaking, configuring the transmission 22 may include, but is not limited to, moving or changing one or more gears of a gear set, actuating one or more clutches, and/or providing a torque coupling between the transmission 22 and the prime mover. For example, if the transmission 22 is an automatic transmission, then configuring the transmission 22 may include engaging and/or disengaging one or more clutches and/or brakes to establish a desired operating mode and a desired gear ratio. Alternatively, if the transmission 22 includes a dual clutch transmission, the configuring the transmission 22 may include, but is not limited to, moving one or more gears into or out of meshing engagement with another gear, and/or engaging or disengaging a first clutch, and engaging or disengaging a second clutch.

Once the transmission 22 has established the requested power flow path through the transmission 22, i.e., the transmission 22 has been configured into the requested operation mode that was selected by the operator via the transmission mode selector 30, a temporary neutral mode may be initiated by the operator. Referring to FIGS. 2 through 4, the temporary neutral mode is initiated when the operator engages both the upshift paddle selector 38 and the downshift paddle selector 40 within a pre-defined engagement time window 44. The pre-defined engagement time window 44 may be between 150 ms and 350 ms. More preferably, the pre-defined engagement time window 44 is approximately equal to 250 ms. However, it should be appreciated that the range for the pre-defined engagement time window 44 and the preferred value of the pre-defined engagement time window 44 are merely exemplary values, and that the pre-defined engagement time window 44 may be defined to include a value other than described herein.

Referring to each of FIGS. 2 through 4, different control scenarios are generally depicted. Within FIGS. 2 through 4, time is shown along a horizontal axis 48, engagement of the upshift paddle selector 38 is shown at time T1, engagement of the downshift paddle selector 40 is shown at time T2, disengagement of the upshift paddle selector 38 is shown at time T3, disengagement of the downshift paddle selector 40 is shown at time T4, the pre-defined engagement time window is shown by dimension line 44, the pre-defined engagement time window 44 ends at time T5, a pre-defined disengagement time window is shown by dimension line 50, the pre-defined disengagement time window 50 ends at time T6, an engagement time interval is shown by reference line 46, a disengagement time interval is shown by dimension line 52, a pre-defined delay time is shown by dimension line 60, the pre-defined delay time 60 ends at time T7, control of the upshift paddle selector 38 is represented by line 54, and control of the downshift paddle selector 40 is represented by line 56.

In order to determine if the upshift paddle selector 38 and the downshift paddle selector 40 were engaged within the pre-defined engagement time window 44, the transmission control module 24 may measure the engagement time interval 46 between the engagement of one of the upshift paddle selector 38 and the downshift paddle selector 40, and the engagement of the other of the upshift paddle selector 38 and the downshift paddle selector 40. For example, referring to FIG. 2, the upshift paddle selector 38 is engaged at time T1. At time T1, the transmission control module 24 may start a timer 58. The transmission control module 24 may end the timer 58 when the downshift paddle selector 40 is engaged. As shown in FIG. 2, the downshift paddle selector 40 is engaged at time T2. The engagement time interval 46 is the period of time between when the upshift paddle selector 38 is engaged, i.e., time T1, and the time the downshift paddle selector 40 is engaged, i.e., time T2. The pre-defined engagement time window 44 begins at time T1, and ends at time T5. The transmission control module 24 may then compare the engagement time interval 46 to the pre-defined engagement time window 44 to determine if the engagement time interval 46 is less than the pre-defined engagement time window 44, if the engagement time interval 46 is equal to the pre-defined engagement time window 44, or if the engagement time interval 46 is greater than the pre-defined engagement time window 44.

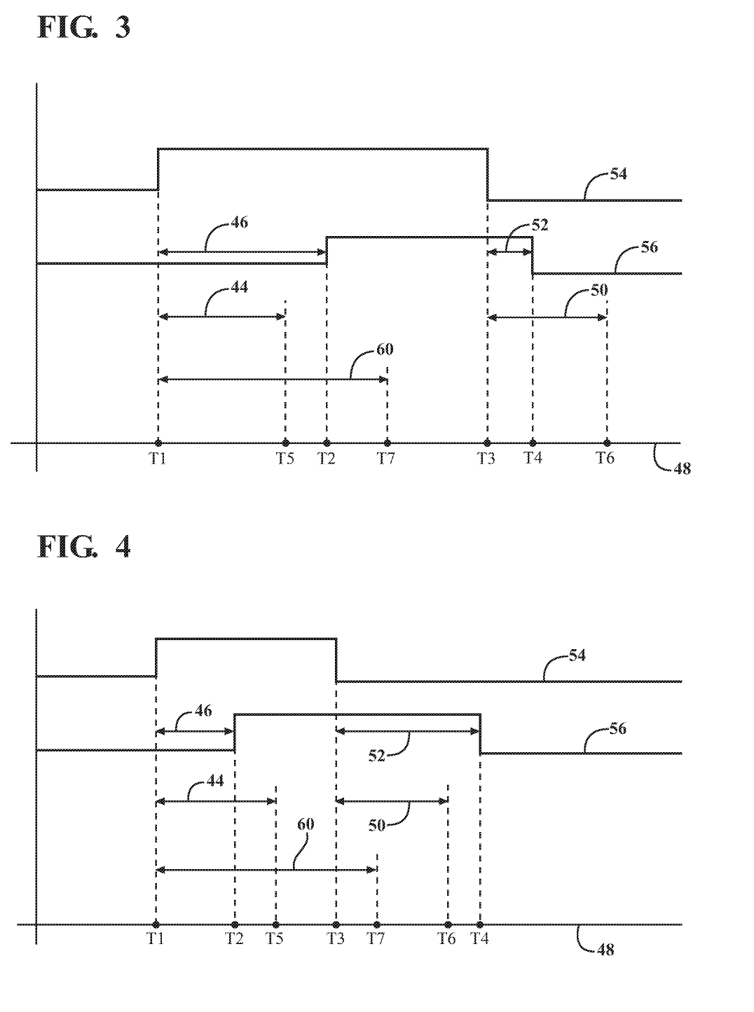

The upshift paddle selector 38 and the downshift paddle selector 40 are both engaged within the pre-defined engagement time window 44 when the engagement time interval 46 is equal to or less than the pre-defined engagement time window 44. As shown in the scenario of FIG. 3, the upshift paddle selector 38 and the downshift paddle selector 40 are not both engaged within the pre-defined engagement time window 44 when the engagement time interval 46 is greater than the pre-defined engagement time window 44. As shown in the scenario of FIG. 2, both the upshift paddle selector 38 and the downshift paddle selector 40 are engaged within the pre-defined engagement time window 44, because the engagement time interval 46 is less than the pre-defined engagement time window 44.

When the upshift paddle selector 38 and the downshift paddle selector 40 are both engaged within the pre-defined engagement time window 44, such as shown in FIG. 2, the temporary neutral mode is initiated. As shown in FIG. 2, the temporary neutral mode is initiated at time T2. Initiating the temporary neutral mode includes disengaging at least one clutch of the transmission 22 to prevent power flow through the transmission 22, without otherwise changing the power flow path through the transmission 22. For example, if the transmission 22 includes a dual clutch transmission 22, then initiating the temporary neutral mode includes disengaging both clutches of the dual clutch transmission 22, while keeping the gears in meshing engagement with each other to otherwise maintain the selected power flow path, e.g., the forward drive mode. If the transmission 22 includes an automatic transmission 22, the initiating the temporary neutral mode may include, for example, disengaging all of the clutches and/or brakes of the transmission 22, but keeping all of the clutches and/or brakes pressurized and ready for quick engagement.

It should be appreciated that the transmission 22 is not re-configured into the true neutral mode of the transmission 22 when the temporary neutral mode is initiated. Accordingly, the temporary neutral mode only simulates the neutral mode of the transmission 22. It should be appreciated that the actual, true neutral mode of the transmission 22 is associated with the transmission mode selector 30 being positioned to select the neutral mode. The temporary neutral mode does not include the selection of the true neutral mode of the transmission 22, and as such, does not cause the transmission mode indicator 32 to change to indicate that the current mode of the transmission 22 is neutral. Rather, the transmission mode indicator 32 remains in selected power flow path, e.g., the forward drive mode or the rearward drive mode. It should be appreciated that selection of the true neutral mode results in the transmission control module 24 configuring the transmission 22 into a state in which power flow through the transmission 22 is prevented when the clutches of the transmission 22 are engaged to transmit torque. For example, the true neutral mode of the transmission 22 may include moving the gears out of meshing engagement with each other. In contrast, the temporary neutral mode does not move the gears out of meshing engagement, but rather only disengages one or more clutches so that torque is not transferred to the gears.

Once the transmission control module 24 has initiated the temporary neutral mode, the transmission control module 24 may also modify the transmission mode indicator 32 at the transmission mode selector 30 or the second transmission mode indicator 34 on the instrument panel 36 to indicate that the transmission 22 is currently disposed in the temporary or simulated neutral mode. As noted above, because the transmission control module 24 does not otherwise change the requested power flow path when initiating the temporary neutral mode, the transmission mode selector 30 remains in the selected position, e.g., the forward drive mode or the rearward drive mode. However, because at least one clutch in the transmission 22 has been disengaged as part of the temporary neutral mode, the transmission control module 24 may modify the transmission mode indicator 32 on the transmission mode selector 30, or the second transmission mode indicator 34 on the instrument panel 36, to indicate that the transmission 22 is currently configured in the temporary neutral mode. For example, the transmission mode indicator 32 on the transmission mode selector 30 may remain un-altered to indicate that the transmission 22 is still generally configured in the requested power flow path, e.g., the forward drive mode or the rearward drive mode, and the second transmission mode indicator 34 on the instrument panel 36 may be altered to indicate that the transmission 22 is currently configured in the temporary neutral mode. The second transmission mode indicator 34 may be altered in any suitable manner, such as by changing a color of the display or background, adding additional indicia, or completely changing the shown symbol.

It should be appreciated that other restrictions and/or requirements may be applied in order to initiate the temporary neutral mode. For example, the transmission control module 24 may only allow initiation of the temporary neutral mode when a speed of the vehicle 20 is equal to or less than a maximum allowed speed, and/or a throttle position of the vehicle 20 is equal to or less than a maximum allowed throttle position. It should be appreciated that other requirements or restrictions may be applied to limit initiation of the temporary neutral mode if desired.

The transmission control module 24 may execute other functions as part of the temporary neutral mode as well. For example, when the upshift paddle selector 38 and the downshift paddle selector 40 are both engaged within the pre-defined engagement time window 44, as described above, the transmission control module 24 may also configure the vehicle 20 for an optimized speed launch. An optimized speed launch may include preparing and setting various different operating parameters to enable the fastest launch that is possible by the vehicle 20. For example, the prime mover, e.g., an internal combustion engine, may be revved up to an optimum speed, various traction control elements may be engaged or limited, etc. The specific details required to place the vehicle 20 in condition for the optimized speed launch are not pertinent to the teachings of this disclosure, and are therefore not described herein.

As noted above, when both the upshift paddle selector 38 and the downshift paddle selector 40 are engaged within the pre-defined engagement time window 44, then the transmission control module 24 initiates the temporary neutral mode as described above. Additionally, when the temporary neutral mode is initiated, the transmission control module 24 does not execute either an upshift or a downshift as would otherwise be requested by the engagement of the upshift paddle selector 38 and the downshift paddle selector 40 respectively. However, if the both the upshift paddle selector 38 and the downshift paddle selector 40 are not both engaged within the pre-defined engagement time window 44, then the transmission control module 24 does not initiate the temporary neutral mode.

Upon the engagement of the first of the upshift paddle selector 38 and the downshift paddle selector 40, the transmission control module 24 delays displaying an indication of the requested upshift or downshift respectively, for a pre-defined delay time 60, until after the pre-defined engagement time window 44 has elapsed, to determine if the operator will engage the other of the upshift paddle selector 38 and the downshift paddle selector 40 within the pre-defined engagement time window 44 to request the temporary neutral mode. As an exemplary embodiment, the pre-defined delay time 60 may equal approximately 500 ms. However, it should be appreciated that the pre-defined delay time 60 may be defined to equal some other value. Accordingly, upon the engagement of the first of the upshift paddle selector 38 and the downshift paddle selector 40, the transmission control module 24 may begin to initiate the requested upshift or downshift respectively, while not displaying or otherwise indicating the requested gear shift, until after the pre-defined delay time 60 has elapsed, so that the transmission control module 24 may determine if the temporary neutral mode is selected.

If the operator fails to engage both the upshift paddle selector 38 and the downshift paddle selector 40 within the pre-defined engagement time window 44, then the transmission control module 24 executes a gear shift in the transmission 22, after the pre-defined delay time 60, to fulfill the requested upshift or downshift, and displays an indication or signal indicated the upshift and/or downshift. For example, referring to FIG. 3, the upshift paddle selector 38 is engaged at time T1, and the downshift paddle selector 40 is engaged at time T2. The pre-defined engagement time window 44 begins at time T1, and ends at time T5. The pre-defined delay time 60 begins at time T1, and ends at time T7. Because the downshift paddle selector 40 was not engaged within the pre-defined engagement time window 44, as shown in FIG. 3, the transmission 22 executes a gear ratio upshift requested by the engagement of the upshift paddle selector 38 at time T1, at the end of the pre-defined delay time 60 at time T7.

Once the temporary neutral mode is initiated, the transmission control module 24 maintains the temporary neutral mode so long as at least one of the upshift paddle selector 38 and the downshift paddle selector 40 is held in their respective engaged positions. Accordingly, the length or duration of the temporary neutral mode is dependent upon the operator holding at least one of the upshift paddle selector 38 and the downshift paddle selector 40 in their respective engaged positions. The engaged positions of the upshift paddle selector 38 and the downshift paddle selector 40 may be defined in any manner, and are dependent upon the specific configuration and/or operation of the upshift paddle selector 38 and the downshift paddle selector 40 respectively. Typically, the upshift paddle selector 38 and the downshift paddle selector 40 are “engaged” by pressing the respective paddle from an initial position into a respective engaged position, and are automatically disengaged and automatically move from the engaged position back to their respective initial position when released by the operator. Accordingly, the operator must press both the upshift paddle selector 38 and the downshift paddle selector 40 to initiate the temporary neutral mode, and must hold at least one of the upshift paddle selector 38 and the downshift paddle selector 40 in their respective engaged position to maintain the temporary neutral mode.

When at least one of the upshift paddle selector 38 and the downshift paddle selector 40 is disengaged, after initiation of the temporary neutral mode, such as indicated at time T3 in FIG. 2, the transmission control module 24 maintains the temporary neutral mode of the transmission 22. When both the upshift paddle selector 38 and the downshift paddle selector 40 are both disengaged, such as shown at time T4 in FIG. 2, the transmission control module 24 ends the temporary neutral mode of the transmission 22. Specifically, as shown in FIG. 2, the transmission control module 24 ends the temporary neutral mode of the transmission 22 at time T4. In order to end the temporary neutral mode, the at least one clutch of the transmission 22 that was disengaged to prevent power flow through the transmission 22 during initiation of the temporary neutral mode, is automatically re-engaged to allow or re-establish power flow through the transmission 22. Because the transmission 22 was not otherwise re-configured during the initiation of the temporary neutral mode, re-engagement of the clutches of the transmission 22 re-establishes the power flow path, without having to re-configure other aspects of the transmission 22. This is because the transmission 22 was not reconfigured into the true neutral mode. As described above, if the transmission 22 were re-configured into the true neutral operating mode, then the engagement of the clutches would still not establish a power flow path through the transmission 22.

The rate at which an output torque of the transmission 22 may be increased is dependent upon whether both of the upshift paddle selector 38 and the downshift paddle selector 40 were disengaged within the pre-defined disengagement time window 50, or were not both disengaged within the pre-defined disengagement time window 50.

In order to determine if the upshift paddle selector 38 and the downshift paddle selector 40 were disengaged within the pre-defined disengagement time window 50, the transmission control module 24 may measure the disengagement time interval 52 between the disengagement of one of the upshift paddle selector 38 and the downshift paddle selector 40, and the disengagement of the other of the upshift paddle selector 38 and the downshift paddle selector 40. For example, referring to FIG. 2, the upshift paddle selector 38 is disengaged at time T3. At time T3, the transmission control module 24 may start the timer 58. The transmission control module 24 may end the timer 58 when the downshift paddle selector 40 is disengaged. As shown in FIG. 2, the downshift paddle selector 40 is disengaged at time T4. The disengagement time interval 52 is the period of time between when the upshift paddle selector 38 is disengaged, i.e., time T3, and the time the downshift paddle selector 40 is disengaged, i.e., time T4. The pre-defined disengagement time window 50 begins at time T3, and ends at time T6. The transmission control module 24 may then compare the disengagement time interval 52 to the pre-defined disengagement time window 50 to determine if the disengagement time interval 52 is less than the pre-defined disengagement time window 50, if the disengagement time interval 52 is equal to the pre-defined disengagement time window 50, or if the dis engagement time interval 46 is greater than the pre-defined disengagement time window 50.

The upshift paddle selector 38 and the downshift paddle selector 40 are both disengaged within the pre-defined disengagement time window 50 when the disengagement time interval 52 is equal to or less than the pre-defined disengagement time window 50. The upshift paddle selector 38 and the downshift paddle selector 40 are not both disengaged within the pre-defined disengagement time window 50 when the disengagement time interval 52 is greater than the pre-defined disengagement time window 50. As can be seen in the example shown in FIG. 2, both the upshift paddle selector 38 and the downshift paddle selector 40 are disengaged within the pre-defined disengagement time window 50, because the disengagement time interval 52 is less than the pre-defined disengagement time window 50.

Referring to FIG. 4, the upshift paddle selector 38 is disengaged at time T3. The downshift paddle selector 40 is disengaged at time T4. The disengagement time interval 52 is the period of time between when the upshift paddle selector 38 is disengaged, i.e., time T3, and the time the downshift paddle selector 40 is disengaged, i.e., time T4. The pre-defined disengagement time window 50 begins at time T3, and ends at time T6. As can be seen in the example shown in FIG. 4, the upshift paddle selector 38 and the downshift paddle selector 40 are not both disengaged within the pre-defined disengagement time window 50, because the disengagement time interval 52 is greater than the pre-defined disengagement time window 50.

The pre-defined disengagement time window 50 may be between 150 ms and 350 ms. More preferably, the pre-defined disengagement time window 50 is approximately equal to 250 ms. However, it should be appreciated that the range for the pre-defined disengagement time window 50 and the preferred value of the pre-defined disengagement time window 50 are merely exemplary values, and that the pre-defined disengagement time window 50 may be defined to include a value other than described herein.

When the upshift paddle selector 38 and the downshift paddle selector 40 are both disengaged within the pre-defined disengagement time window 50, such as shown in FIG. 2, the output torque of the transmission 22, i.e., the torque that the transmission 22 outputs, is increased from zero to a requested torque value at a first rate. The requested torque value may include any torque value, and may be requested in any suitable manner, such as by the depression of an accelerator pedal, or by command from an engine control unit executing an optimized speed launch, such as described above.

When the upshift paddle selector 38 and the downshift paddle selector 40 are not both disengaged within the pre-defined disengagement time window 50, such as shown in FIG. 4, the output torque is increased from zero to the requested torque value at a second rate. The second rate is different than the first rate. Preferably, the second rate is less than the first rate. The first rate may be defined as a maximum allowable torque increase rate, whereas the second rate may be defined as a controlled or limited torque increase rate. Accordingly, if both the upshift paddle selector 38 and the downshift paddle selector 40 are disengaged within the pre-defined disengagement time window 50, then the transmission control module 24 allows torque output to increase at the maximum allowable rate. However, if the upshift paddle selector 38 and the downshift paddle selector 40 are not both disengaged within the pre-defined disengagement time window 50, then the transmission control module 24 only allows torque output to increase at a lower, torque limited rate.

The transmission control module 24 continuously monitors the upshift paddle selector 38 and the downshift paddle selector 40 to determine if one or both of the upshift paddle selector 38 or the downshift paddle selector 40 is operating properly, or is not operating properly. If the transmission control module 24 determines that one or both of the upshift paddle selector 38 or the downshift paddle selector 40 are not operating properly, e.g., the transmission control module 24 identifies a fault in either the upshift paddle selector 38 or the downshift paddle selector 40, then the transmission control module 24 inactivates both the upshift paddle selector 38 and the downshift paddle selector 40, disables the simulated neutral algorithm 28, and controls the operation of the transmission 22 automatically.

The transmission control module 24 may include diagnostic software to test and verify the operation of the upshift paddle selector 38 and the downshift paddle selector 40. The diagnostic software may evaluate the upshift paddle selector 38 and the downshift paddle selector 40 in any suitable manner to identify a fault in either the upshift paddle selector 38 or the downshift paddle selector 40. Furthermore, both the upshift paddle selector 38 and the downshift paddle selector 40 may include a single switch in a resistor ladder configuration. By using a switch in a resistor ladder, a fault in the upshift paddle selector 38 and/or the downshift paddle selector 40 may be identified if the voltage is not within nominal voltages specified by the resistor ladder. Additionally, each of the upshift paddle selector 38 and the downshift paddle selector 40 may be electrically isolated from each other to further aid in the identification of a fault, i.e., improper operation.

In addition to the simulated neutral algorithm 28 described above, the transmission control module 24 may be programmed to execute a specialized upshift control and/or a specialized downshift control. As noted above, the transmission 22 may be controlled automatically by the transmission control module 24. This may be referred to as automatic control. Alternatively, if desired, the operator may use the upshift paddle selector 38 and the downshift paddle selector 40 to request that the transmission control module 24 shift to the transmission 22 into the next available higher gear ratio or lower gear ratio respectively. This may be referred to as manual control. Typical operation of paddle shifters includes the engagement and immediate disengagement of a paddle shifter. Each engagement/disengagement sequence causes an increase or decrease in the gear ratio to the next available gear ratio, either up or down, if the transmission 22 may be safely operated in the requested gear ratio.

The specialized upshift control and the specialized downshift control provide added functionality to manual control of the transmission 22. When using the specialized upshift control, engaging and holding the upshift paddle selector 38 for a first time period results in a request to upshift to the next available gear, i.e., upshift 1 gear. When using automatic control of the transmission 22, and the operator engages and holds the upshift paddle selector 38 for the first time period, the transmission control module 24 enters a temporary tap control, which allows the operator to request a change in the gear ratio by engaging the upshift paddle selector 38, and changes the gear ratio of the transmission 22 to the next available higher gear ratio. If the operator holds the upshift paddle selector 38 for a second time period, then the transmission control module 24 exits the temporary tap control. As an exemplary embodiment, first time period may be defined to equal 25 ms, and the second time period may be defined to equal 1000 ms. However, it should be appreciated that the first time period and the second time period may be defined to equal some other value. When using manual control of the transmission 22, and the operator engages and holds the upshift paddle selector 38 for the first time period, the transmission control module 24 changes the gear ratio of the transmission 22 to the next available higher gear ratio.

When using the specialized downshift control, engaging and holding the downshift paddle selector 40 for a first time period results in a request to downshift to the next available gear, i.e., downshift 1 gear. When using automatic control of the transmission 22, and the operator engages and holds the downshift paddle selector 40 for the first time period, the transmission control module 24 enters the temporary tap control, which allows the operator to request a change in the gear ratio by engaging the downshift paddle selector 40, and changes the gear ratio of the transmission 22 to the next available lower gear ratio. When using manual control of the transmission 22, and the operator engages and holds the downshift paddle selector 40 for the first time period, the transmission control module 24 changes the gear ratio of the transmission 22 to the next available lower gear ratio.

If the transmission 22 is currently being controlled using the temporary tap control or manual control, and the operator holds the downshift paddle selector 40 for a second time period, then the transmission control module 24 downshifts the transmission 22 to the lowest permitted gear for the current operating conditions of the vehicle 20. If the operator holds the downshift paddle selector 40 for a third time period, then the transmission control module 24 continuously downshifts to the lowest permitted gear, until the transmission 22 is configured in the lowest gear ratio of the transmission 22. As an exemplary embodiment, first time period may be defined to equal 25 ms, the second time period may be defined to equal 500 ms, and the third time period may be defined to equal 1000 ms. However, it should be appreciated that the first time period, the second time period, and the third time period may be defined to equal some other value.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of controlling an electronically controlled transmission of a vehicle, the method comprising:
positioning a transmission mode selector in a forward drive mode or a rearward drive mode to request a power flow path through the transmission;
configuring the transmission to provide the requested power flow path through the transmission;
engaging both an upshift paddle selector and a downshift paddle selector within a pre-defined engagement time window; and
disengaging at least one clutch of the transmission to prevent power flow through the transmission, without otherwise changing the power flow path through the transmission, to simulate a neutral operating mode of the transmission, when the upshift paddle selector and the downshift paddle selector are both engaged within the pre-defined engagement time window.

2. The method set forth in claim 1, further comprising measuring an engagement time interval between the engagement of one of the upshift paddle selector and the downshift paddle selector and the engagement of the other of the upshift paddle selector and the downshift paddle selector.

3. The method set forth in claim 2, wherein the upshift paddle selector and the downshift paddle selector are both engaged within the pre-defined engagement time window when the engagement time interval is equal to or less than the pre-defined engagement time window, and wherein the upshift paddle selector and the downshift paddle selector are not both engaged within the pre-defined engagement time window when the engagement time interval is greater than the pre-defined engagement time window.

4. The method set forth in claim 1, wherein the pre-defined engagement time window is between 150 ms and 350 ms.

5. The method set forth in claim 1, further comprising modifying a transmission mode indicator to indicate that the transmission is currently disposed in a simulated neutral mode when all clutches of the transmission are engaged and the transmission mode selector is disposed in either the forward drive mode or the rearward drive mode.

6. The method set forth in claim 1, wherein the transmission is not re-configured to into a physical neutral mode, in which power flow through the transmission is prevented when any clutches of the transmission are engaged to transmit torque, when the upshift paddle selector and the downshift paddle selector are both engaged within the pre-defined engagement time window.

7. The method set forth in claim 1, further comprising holding at least one of the upshift paddle selector and the downshift paddle selector in their respective engaged positions, with all clutches of the transmission disengaged, to maintain the simulated neutral operating mode of the transmission.

8. The method set forth in claim 7, further comprising disengaging both of the upshift paddle selector and the downshift paddle selector to end the simulated neutral operating mode.

9. The method set forth in claim 8, further comprising engaging the at least one clutch of the transmission that was disengaged to prevent power flow through the transmission, to re-establish power flow through the transmission, when both of the upshift paddle selector and the downshift paddle selector are disengaged.

10. The method set forth in claim 8, further comprising measuring a disengagement time interval between the disengagement of one of the upshift paddle selector and the downshift paddle selector and the disengagement of the other of the upshift paddle selector and the downshift paddle selector.

11. The method set forth in claim 10, wherein the upshift paddle selector and the downshift paddle selector are both disengaged within the pre-defined disengagement time window when the disengagement time interval is equal to or less than the pre-defined disengagement time window, and wherein the upshift paddle selector and the downshift paddle selector are not both disengaged within the pre-defined disengagement time window when the disengagement time interval is greater than the pre-defined disengagement time window.

12. The method set forth in claim 8, wherein the pre-defined disengagement time window is between 150 ms and 350 ms.

13. The method set forth in claim 9, wherein an output torque is increased from zero to a requested torque value at a first rate when the upshift paddle selector and the downshift paddle selector are both disengaged within the pre-defined disengagement time window, and the output torque is increased from zero to the requested torque value at a second rate that is different than the first rate when the upshift paddle selector and the downshift paddle selector are not both disengaged within the pre-defined disengagement time window.

14. The method set forth in claim 1, wherein disengaging the at least one clutch of the transmission to prevent power flow through the transmission when the upshift paddle selector and the downshift paddle selector are both engaged within the pre-defined engagement time window, is further defined as disengaging the at least one clutch of the transmission to prevent power flow through the transmission when the upshift paddle selector and the downshift paddle selector are both engaged within the pre-defined engagement time window, a speed of the vehicle is equal to or less than a maximum allowed speed, and a throttle position of the vehicle is equal to or less than a maximum allowed throttle position.

15. The method set forth in claim 1, further comprising identifying a fault in either the upshift paddle selector or the downshift paddle selector.

16. The method set forth in claim 15, further comprising inactivating both the upshift paddle selector and the downshift paddle selector when a fault is identified in either the upshift paddle selector or the downshift paddle selector.

17. The method set forth in claim 1, further comprising configuring the vehicle for optimized speed launch when the upshift paddle selector and the downshift paddle selector are both engaged within the pre-defined engagement time window.

18. The method set forth in claim 1, further comprising executing a gear shift in the transmission when one of the upshift paddle selector or the downshift paddle selector is engaged, but both of the upshift paddle selector and the downshift paddle selector are not engaged within the pre-defined engagement time window.

19. A method of controlling a transmission of a vehicle, the vehicle including an upshift paddle selector for manually requesting an upshift in the transmission, and a downshift paddle selector for manually requesting a downshift in the transmission, the method comprising:
initiating a temporary neutral mode of the transmission, in which at least one clutch of the transmission is disengaged to prevent power flow through the transmission, when the upshift paddle selector and the downshift paddle selector are both engaged within a pre-defined engagement time window;
holding at least one of the upshift paddle selector and the downshift paddle selector in their respective engaged positions to maintain the temporary neutral mode of the transmission; and
ending the temporary neutral mode of the transmission, in which the at least one clutch that was disengaged to prevent power flow through the transmission is automatically re-engaged to allow power flow through the transmission, when both the upshift paddle selector and the downshift paddle selector is disengaged.

20. The method set forth in claim 19, wherein an output torque of the transmission is increased from zero to a requested torque value at a first rate when the upshift paddle selector and the downshift paddle selector are both disengaged within a pre-defined disengagement time window, and the output torque is increased from zero to the requested torque value at a second rate that is slower than the first rate when the upshift paddle selector and the downshift paddle selector are not both disengaged within the pre-defined disengagement time window.
